(19) United States
(12) Patent Application Publication
(10) Pub. No.: US 2026/0050179 A1
(43) Pub. Date: Feb. 19, 2026

(54) PHYSICAL ALIGNMENT HOLES OR NOTCHES IN OPHTHALMIC LENSES FOR USE IN LENSSTACK PRECISION ALIGNMENT DURING ASSEMBLY

(71) Applicant: Applied Materials, Inc., Santa Clara, CA (US)

(72) Inventors: Darren IHMELS, Port Moody (CA); Kazuya DAITO, Milpitas, CA (US)

(21) Appl. No.: 19/301,444

(22) Filed: Aug. 15, 2025

Related U.S. Application Data
(60) Provisional application No. 63/683,888, filed on Aug. 16, 2024.

(51) Int. Cl. G02C 7/02; G02C 13/00

(52) U.S. Cl. CPC G02C 7/021; G02C 7/022; G02C 13/001; G02C 2202/16

(57) ABSTRACT

An ophthalmic lens assembly includes a first ophthalmic lens and a second ophthalmic lens. The first ophthalmic lens comprises one or more first mechanical fiducials. The one or more first mechanical fiducials comprise a first mechanical fiducial formed at a first location on the first ophthalmic lens. The second ophthalmic lens comprises one or more second mechanical fiducials. The one or more second mechanical fiducials comprise a second mechanical fiducial formed at a second location on the second ophthalmic lens. The first mechanical fiducial and the second mechanical fiducial are aligned with one another.

### CROSS-REFERENCE TO RELATED APPLICATIONS

This Application claims the benefit of U.S. Provisional Application 63/683,888 filed on Aug. 16, 2024, which is hereby expressly incorporated by reference herein in its entirety.

### BACKGROUND

### Field

Embodiments of the present invention generally relate to an ophthalmic lens assembly including ophthalmic lenses having mechanical fiducials formed thereon.

### Description of the Related Art

Ophthalmic lens assemblies include an optical waveguide sandwiched between ophthalmic lenses. The ophthalmic lenses include a push lens attached on top of the optical waveguide and a pull lens attached below the optical waveguide. Typically, the ophthalmic lenses are attached to the waveguide by hand, which can be time consuming.

When stacking ophthalmic lenses it is imperative that the ophthalmic lenses are accurately aligned. Conventionally, to allow for machine stacking of ophthalmic lenses, laser marks are formed on the ophthalmic lenses for proper alignment. The laser marks are typically formed before the ophthalmic lenses are edged. However, due to the positioning tolerances of the vision system of the machine, the final edged lens and the laser fiducial markings may not be accurate enough for use in stack assembly processes.

Therefore, there is a need in the art for forming mechanical fiducials on push and pull lenses that allow for precise lens stacking during assembly.

### SUMMARY

According to one or more embodiments, an ophthalmic lens assembly includes a first ophthalmic lens comprising one or more first mechanical fiducials, the one or more first mechanical fiducials including a first mechanical fiducial formed at a first location on the first ophthalmic lens, and a second ophthalmic lens including one or more second mechanical fiducials, the one or more second mechanical fiducials including a second mechanical fiducial formed at a second location on the second ophthalmic lens, wherein the first mechanical fiducial and the second mechanical fiducial are aligned with one another.

According to one or more embodiments, a method includes forming one or more first mechanical fiducials on a first ophthalmic lens and one or more second mechanical fiducials on a second ophthalmic lens, the one or more first mechanical fiducials including a first mechanical fiducial formed at a first location on the first ophthalmic lens, the one or more second mechanical fiducials including a second mechanical fiducial formed on a second location on the second ophthalmic lens, and forming an ophthalmic lens assembly by attaching the first ophthalmic lens to the second ophthalmic lens with the one or more first mechanical fiducials aligned with the second one or more mechanical fiducials.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1 illustrates a, frontal view of a waveguide, according to one or more embodiments.

FIG. 2 is a flow chart that illustrates a method of forming an ophthalmic lens assembly, according to one or more embodiments.

FIGS. 3A-3B illustrate a top-view of a pull lens and a push lens in a first configuration, according to one or more embodiments.

FIGS. 4A-4B illustrate a top-view of a pull lens and a push lens in a second configuration, according to one or more embodiments.

FIGS. 5A-5B illustrate a top-view of a pull lens and a push lens in a third configuration, according to one or more embodiments.

FIGS. 6A-6B illustrate a top-view of a pull lens and a push lens in a fourth configuration, according to one or more embodiments.

FIG. 7 illustrates a isometric, exploded view of an ophthalmic lens assembly, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

As noted above, when forming ophthalmic lens assemblies it is imperative that the ophthalmic lenses are accurately aligned. Conventionally, to allow for machine stacking of ophthalmic lenses, laser marks are formed on the ophthalmic lenses for proper alignment. The laser marks are typically formed before the ophthalmic lenses are edged. However, due to the positioning tolerances of the vision system of the machine, the final edged lens and the laser fiducial markings may not be accurate enough for use in stack assembly processes. Embodiments here relate to an ophthalmic lens assembly and corresponding method including ophthalmic lenses having fiducials formed thereon to ensure the ophthalmic lenses are accurately aligned.

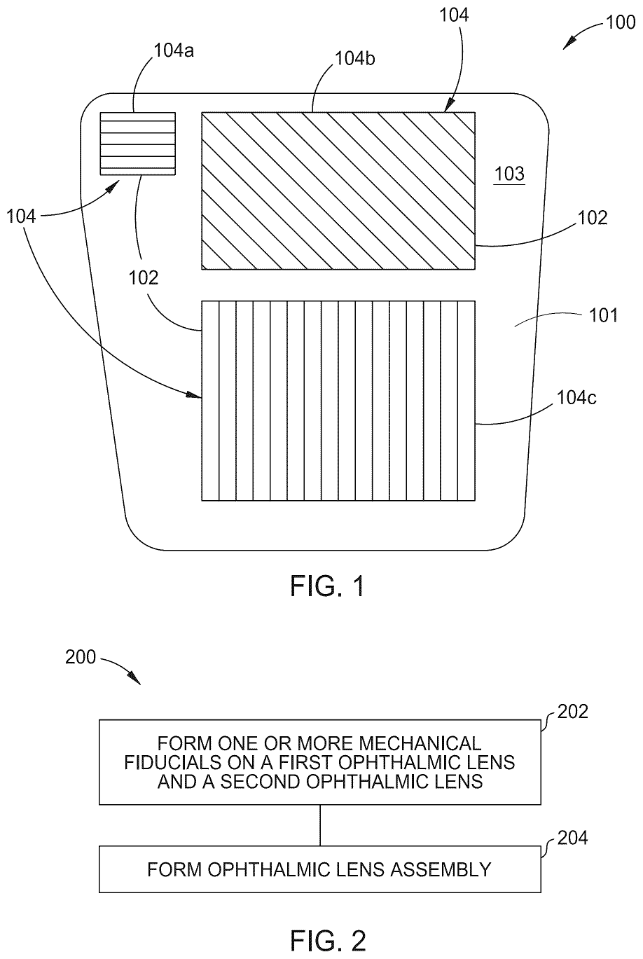

FIG. 1 illustrates a frontal view of a waveguide 100, according to one or more embodiments. It is to be understood that the waveguide 100 described herein is an exemplary waveguide and that other waveguides may be used with or modified to accomplish aspects of the present disclosure. The waveguide 100 includes a plurality of structures 102. The structures 102 may be disposed over, under, or on a surface 103 of a substrate 101, or disposed in the substrate 101. The structures 102 are nanostructures have a sub-micron critical dimension, e.g., a width less than 1 micrometer. Regions of the structures 102 correspond to one or more gratings 104. In one embodiment, which can be combined with other embodiments described herein, the waveguide 100 includes at least a first grating 104a corresponding to an input coupling grating and a third grating 104c corresponding to an output coupling grating. In another embodiment, which can be combined with other embodiments described herein, the waveguide 100 further includes a second grating 104b. The second grating 104b corresponds to a pupil expansion grating or a fold grating.

FIG. 2 is a flow chart that illustrates a method of forming an ophthalmic lens assembly, according to one or more embodiments. At operation 202 of the method 200 one or more mechanical fiducials (alignment features) are formed on a first ophthalmic lens and a second ophthalmic lens. In one or more embodiments, the first ophthalmic lens is a pull lens and the second ophthalmic lens is a push lens (or vice versa).

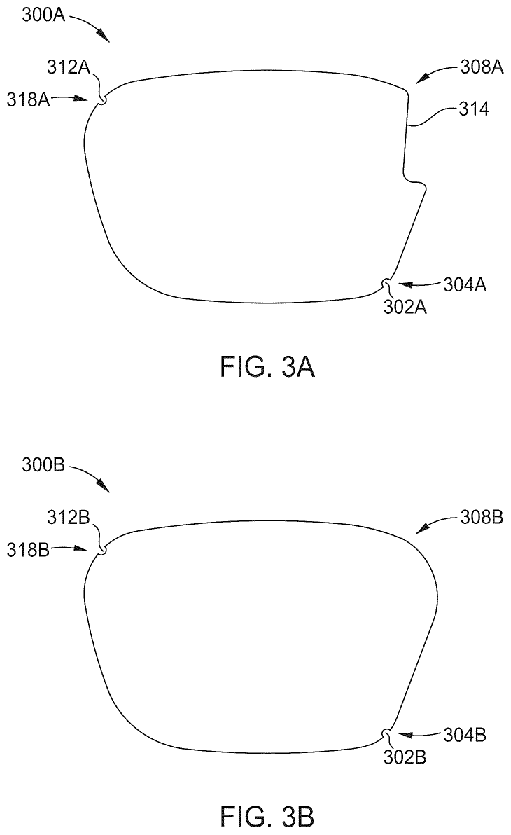

As will be described in more detail below, the one or more mechanical fiducials are used to properly align the pull lens 300A (FIGS. 3A, 4A, 5A, and 6A) with the push lens 300B (FIGS. 3B, 4B, 5B, and 6B). Therefore, identical mechanical fiducials are formed in identical (matching) locations on both the pull lens 300A and the push lens 300B. The pull lens 300A and the push lens 300B include a same quantity of mechanical fiducials.

FIGS. 3A-3B illustrate a top-view of a pull lens 300A and a push lens 300B in a first configuration, according to one or more embodiments. Referring to FIG. 3A, the pull lens 300A includes a mechanical fiducial 302A, a mechanical fiducial 312A, and a cut-out 314. In one or more embodiments, the mechanical fiducial 302A and the mechanical fiducial 312A are formed during the edging of the pull lens 300A. In one or more embodiments, the mechanical fiducial 302A and the mechanical fiducial 312A are formed on different locations of the pull lens 300A.

As illustrated in FIG. 3A, the mechanical fiducial 302A is formed at a first location 304A (i.e., at or close to a first corner) of the pull lens 300A. The mechanical fiducial 312A is formed at a second location 318a (i.e., at or close to a second corner) of the pull lens 300A.

The one or more mechanical fiducials formed on an ophthalmic lens may be of a same type or a different type so long as the first and second ophthalmic lenses have matching mechanical fiducials at matching locations. Types of mechanical fiducials include, but are not limited to notches, through holes, blind holes, or the like. For example, as shown in FIG. 3A (the first configuration), the mechanical fiducial 302A and the mechanical fiducial 312A are notches. The mechanical fiducial 302A and the mechanical fiducial 312A extend to and coincide with an edge 308A of the pull lens 300A. Stated differently, when the mechanical fiducial 302A and the mechanical fiducial 312A are notches, and the first location 304A and the second location 314A coincide with the edge 308A of the pull lens 300A.

Additionally, the one or more mechanical fiducials can be of a same or different shape, as well as a same or different type. The mechanical fiducials may have any suitable shape, such as circular, square, rectangular, oval, crosshairs, or combinations thereof. For example, as illustrated in FIG. 3A, the mechanical fiducial 302A and the mechanical fiducial 312A are circular notches.

The one or more mechanical fiducials on the first ophthalmic lens (pull lens 300A) are aligned with one or more identical fiducials on a second ophthalmic lens (push lens 300B) to ensure the first and second ophthalmic lenses are properly aligned. Therefore, identical mechanical fiducials are formed at matching locations on both the pull lens and the push lens.

Referring to FIG. 3B, the push lens 300B has an identical shape as the pull lens 300A with the exception of the cut-out 314. In the first configuration, the push lens 300B includes a mechanical fiducial 302B and a mechanical fiducial 312B.

In one or more embodiments, the mechanical fiducial 302B and the mechanical fiducial 312B are formed during the edging of the push lens 300B. In one or more embodiments, the mechanical fiducial 302B and the mechanical fiducial 312B are formed on different locations of the push lens 300B.

As illustrated in FIG. 3B, the mechanical fiducial 302B is formed at a first location 304B (i.e., on or near a first corner) of the push lens 300B. The mechanical fiducial 312B is formed at a second location 318B (i.e., near or close to a second corner) of the push lens 300B.

The mechanical fiducial 302A is identical to the mechanical fiducial 302B. The mechanical fiducial 312A is identical to the mechanical fiducial 312B. The mechanical fiducial 302B and the mechanical fiducial 312B are also notches that extend to and coincide with an edge 308B of the push lens 300B. The mechanical fiducial 302A and the mechanical fiducial 302B are located at the same locations on the pull lens 300A and the push lens 300B, respectively. The mechanical fiducial 312A and the mechanical fiducial 312B are located at the same locations on the pull lens 300A and the push lens 300B, respectively. Stated differently, the first location 304A on the pull lens 300A matches the first location 304B on the push lens 300B. The second location 318A on the pull lens 300A matches the second location 318B on the push lens 300B. Advantageously, the pull lens 300A and the push lens 300B are properly aligned by aligning the mechanical fiducial 302A with the mechanical fiducial 302B and aligning the mechanical fiducial 312A with the mechanical fiducial 312B.

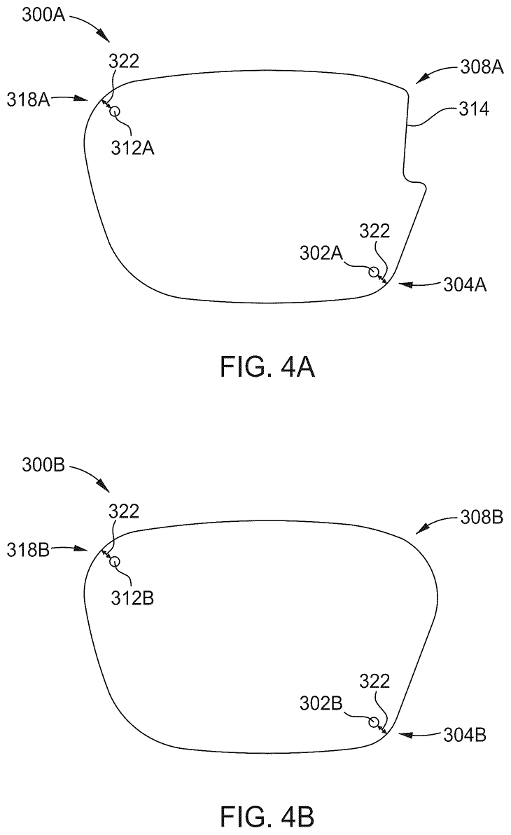

FIGS. 4A-4B illustrate a top-view of the pull lens 300A and the push lens 300B in a second configuration, according to one or more embodiments. As illustrated in FIGS. 4A-4B, in the second configuration, the mechanical fiducials 302A, 302B, 312A, and 312B are circular through holes. In one or more embodiments, mechanical fiducials that are through holes do not coincide with the edge 308A and the edge 308B, respectively. When the mechanical fiducials are through holes, the mechanical fiducials are located a distance from their respective edges 308A and 308B. As illustrated in FIG. 4A, the first location 304A and the second location 318A (i.e., the mechanical fiducial 302A and the mechanical fiducial 312A) are each located at a distance 322 from the edge 308A of the pull lens 300A. As illustrated in FIG. 4B, the first location 304B and the second location 318B (i.e., the mechanical fiducial 302B and the mechanical fiducial 312B) are each located at the distance 322 from the edge 308B of the push lens 300B. In one or more embodiments, the distance 322 is about 200 μm to about 500 μm.

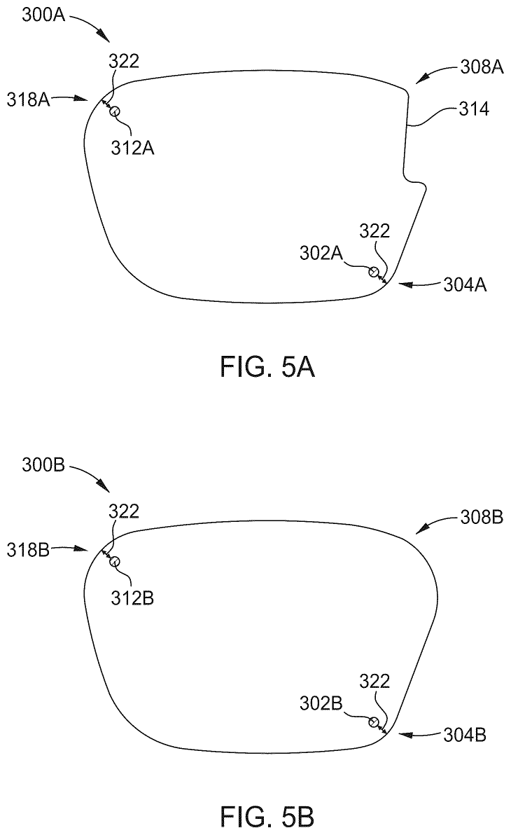

FIGS. 5A-5B illustrate a top-view of the pull lens 300A and the push lens 300B in a third configuration, according to one or more embodiments. As illustrated in FIGS. 5A-5B, in the third configuration, the mechanical fiducials 302A, 302B, 312A, and 312B are circular blind holes. Stated differently, the mechanical fiducials 302A, 302B, 312A, and 312B are holes that extend through a portion of the thickness of the respective pull lens 300A or push lens 300B (i.e., not completely through the respective thickness). In one or more embodiments, mechanical fiducials that are blind holes do not coincide with the edge 308A and the edge 308B, respectively. As illustrated in FIG. 5A, the first location 304A and the second location 318A (i.e., the mechanical fiducial 302A and the mechanical fiducial 312A) are each located at the distance 322 from the edge 308A of the pull lens 300A. As illustrated in FIG. 5B, the first location 304B and the second location 318B (i.e., the mechanical fiducial 302B and the mechanical fiducial 312B) are each located at the distance 322 from the edge 308B of the push lens 300B.

Although FIGS. 3A-3B, 4A-4B, and 5A-5B illustrate a pull lens and a push lens having 2 mechanical fiducials, this is for example purposes only. It is understood that the pull lens 300A and the push lens 300B can include 1 mechanical fiducial or any other suitable quantity of mechanical fiducials required to align the pulls lens 300A with the push lens 300B.

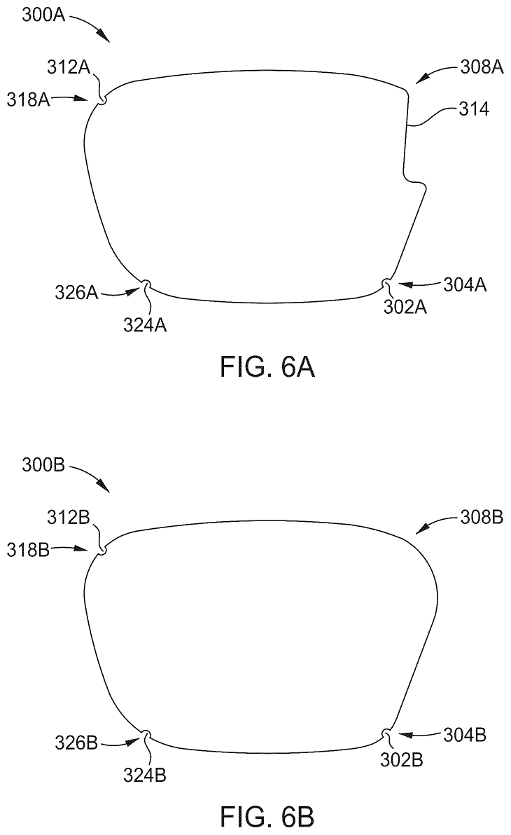

FIGS. 6A-6B illustrate a top-view of the pull lens 300A and the push lens 300B in a fourth configuration, according to one or more embodiments. As illustrated in FIGS. 6A-6B, in the fourth configuration, the pull lens 300A and the push lens 300B further include another fiducial. The pull lens 300A includes a mechanical fiducial 324A formed at a third location 326A of the pull lens 300A. The push lens 300B includes a mechanical fiducial 324B formed at a third location 326B of the push lens 300B. As noted above, the mechanical fiducials 302A, 312A, and 324A can be of the same or different types and have the same or different shapes so long as the mechanical fiducials 302A and 302B, the mechanical fiducials 312A and 312B, and the mechanical fiducials 324A and 324B are identical. As also noted above, the mechanical fiducials 302A and 302B, the mechanical fiducials 312A and 312B, and the mechanical fiducials 324A and 324B are located at matching locations on the pull lens 300A and the push lens 300B, respectively.

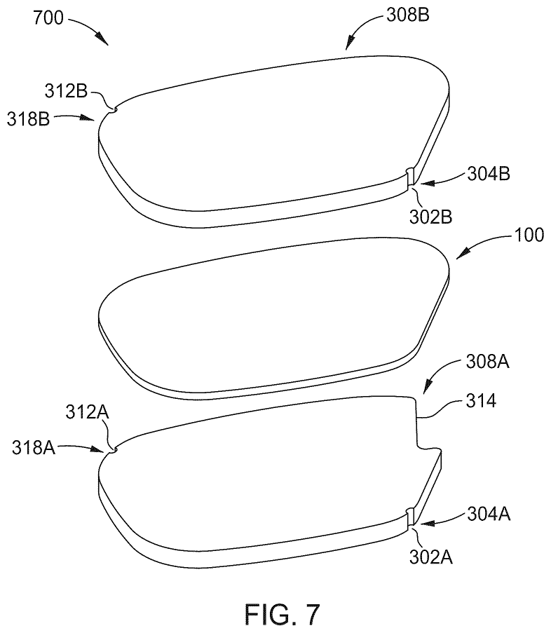

At operation 204 of the method 200, an ophthalmic lens assembly 700 is formed. FIG. 7 illustrates isometric, exploded view of an ophthalmic lens assembly 700, according to one or more embodiments. In one or more embodiments, the ophthalmic lens assembly 700 includes the waveguide 100 sandwiched (attached) between two ophthalmic lenses. In one or more embodiments, the ophthalmic lenses include the pull lens 300A and the push lens 300B. The push lens 300B is disposed over the waveguide 100 (i.e., above the surface 103). The pull lens 300A is disposed below the waveguide 100. The pull lens 300A and the push lens 300B may be attached to the waveguide 100 using any suitable device that can be automated to adhere the lenses to the waveguide 100. As noted above, to ensure that the pull lens 300A and the push lens 300B are accurately aligned, corresponding mechanical fiducials are aligned. For example, as illustrated in FIG. 7, the pull lens 300A and the push lens 300B are in the first configuration (FIGS. 3A-3B). Therefore, to align the pull lens 300A and the push lens 300B, the mechanical fiducials 302A and 302B are aligned, and the mechanical fiducials 312A and 312B are aligned.

As noted above, embodiments herein relate to adding mechanical fiducials to a first ophthalmic lens and a second ophthalmic lens (push lens and pull lens) of an ophthalmic lens assembly during edging. Advantageously, the mechanical fiducials allow for more accurate machine stacking (alignment) of the ophthalmic lenses than the typically used laser marks due to positioning tolerances of the vision system of the machine.

While the foregoing is directed to examples of the present disclosure, other and further examples of the disclosure may be devised without departing from the basic scope thereof, and the scope thereof is determined by the claims that follow.

What is claimed is:

1. An ophthalmic lens assembly comprising:
a first ophthalmic lens comprising one or more first mechanical fiducials, the one or more first mechanical fiducials comprising a first mechanical fiducial formed at a first location on the first ophthalmic lens; and
a second ophthalmic lens comprising one or more second mechanical fiducials, the one or more second mechanical fiducials comprising a second mechanical fiducial formed at a second location on the second ophthalmic lens, wherein the first mechanical fiducial and the second mechanical fiducial are aligned with one another.

2. The ophthalmic lens assembly of claim 1, wherein the first mechanical fiducial and the second mechanical fiducial are of the same type and shape.

3. The ophthalmic lens assembly of claim 1, wherein the first location and the second location are matching locations on the first ophthalmic lens and the second ophthalmic lens.

4. The ophthalmic lens assembly of claim 1, wherein the first mechanical fiducial is a notch that extends to and coincides with an edge of the first ophthalmic lens and the second mechanical fiducial is a notch that extends to and coincides with an edge of the second ophthalmic lens.

5. The ophthalmic lens assembly of claim 1, wherein the first mechanical fiducial and the second mechanical fiducial are through holes, the first location is located at a distance from an edge of the first ophthalmic lens, and the second location is located at the distance from an edge of the second ophthalmic lens.

6. The ophthalmic lens assembly of claim 1, wherein the first mechanical fiducial and the second mechanical fiducial are blind holes, the first location is located at a distance from an edge of the first ophthalmic lens, and the second location is located at the distance from an edge of the second ophthalmic lens.

7. The ophthalmic lens assembly of claim 1, wherein:
the one or more first mechanical fiducials further comprise a third mechanical fiducial formed at a third location on the first ophthalmic lens; and
the one or more second mechanical fiducials further comprise a fourth mechanical fiducial formed at a fourth location on the second ophthalmic lens, wherein the third mechanical fiducial and the fourth mechanical fiducial are aligned with one another.

8. The ophthalmic lens assembly of claim 1, further comprising a waveguide located between the first ophthalmic lens and the second ophthalmic lens.

9. The ophthalmic lens assembly of claim 8, wherein the first ophthalmic lens is a push lens, the second ophthalmic lens is a pull lens, and the first ophthalmic lens is disposed over the waveguide.

10. The ophthalmic lens assembly of claim 1, wherein the second ophthalmic lens includes a cut-out.

11. A method comprising:
forming one or more first mechanical fiducials on a first ophthalmic lens and one or more second mechanical fiducials on a second ophthalmic lens, the one or more first mechanical fiducials comprising a first mechanical fiducial formed at a first location on the first ophthalmic lens, the one or more second mechanical fiducials comprising a second mechanical fiducial formed on a second location on the second ophthalmic lens; and
forming an ophthalmic lens assembly by attaching the first ophthalmic lens to the second ophthalmic lens with the one or more first mechanical fiducials aligned with the second one or more mechanical fiducials.

12. The method of claim 11, wherein the first mechanical fiducial and the second mechanical fiducial are of the same type and shape.

13. The method of claim 11, wherein the first location and the second location are matching locations on the first ophthalmic lens and the second ophthalmic lens.

14. The method of claim 11, wherein the first mechanical fiducial is a notch that extends to and coincides with an edge of the first ophthalmic lens and the second mechanical fiducial is a notch that extends to and coincides with an edge of the second ophthalmic lens.

15. The method of claim 11, wherein the first mechanical fiducial and the second mechanical fiducial are through holes, the first location is located at a distance from an edge of the first ophthalmic lens, and the second location is located at the distance from the edge of the second ophthalmic lens.

16. The method of claim 11, wherein the first mechanical fiducial and the second mechanical fiducial are blind holes, the first location is located at a distance from an edge of the first ophthalmic lens, and the second location is located at the distance from the edge of the second ophthalmic lens.

17. The method of claim 11, wherein:
the one or more first mechanical fiducials comprise a third mechanical fiducial formed at a third location on the first ophthalmic lens;
the one or more second mechanical fiducials further comprise a fourth mechanical fiducial formed on a fourth location on the second ophthalmic lens; and
forming the ophthalmic lens assembly further comprises aligning the third mechanical fiducial and the fourth mechanical fiducial.

18. The method of claim 11, wherein the ophthalmic lens assembly includes a waveguide located between the first ophthalmic lens and the second ophthalmic lens.

19. The method of claim 18, wherein the first ophthalmic lens is a push lens, the second ophthalmic lens is a pull lens, and forming the ophthalmic lens assembly further comprises attaching the first ophthalmic lens over the waveguide and attaching the second ophthalmic lens under the waveguide.

20. The method of claim 19, wherein the second ophthalmic lens includes a cut-out.
